(19) United States
(12) Patent Application Publication
(10) Pub. No.: US 2021/0144638 A1
(43) Pub. Date: May 13, 2021

(54) Method And Apparatus For Determining Monitoring Occasion Of Power Saving Signal In Mobile Communications

(71) Applicant: MediaTek Inc., Hsinchu City (TW)

(72) Inventors: Yi-Ju Liao, Hsinchu City (TW); Wei-De Wu, Hsinchu City (TW)

(21) Appl. No.: 17/063,910

(22) Filed: Oct. 6, 2020

Related U.S. Application Data
(60) Provisional application No. 62/932,570, filed on Nov. 8, 2019.

(51) Int. Cl. H04W 52/02; H04W 24/08; H04W 76/28; H04W 80/08; H04W 72/04; H04L 5/00; H04W 8/24

(52) U.S. Cl. CPC H04W 52/0229; H04W 24/08; H04W 76/28; H04W 8/24; H04W 72/0446; H04L 5/0094; H04W 80/08

(57) ABSTRACT

Various solutions for determining monitoring occasion for power saving signal with respect to user equipment and network apparatus in mobile communications are described. An apparatus may receive a configuration of at least one search space set for power saving signal. The apparatus may determine at least one monitoring occasion of the search space set according to a starting point and a monitoring duration. The apparatus may monitor a power saving signal within the monitoring occasion. The apparatus may determine whether to wake up from a power saving mode according to the power saving signal.

### CROSS REFERENCE TO RELATED PATENT APPLICATION(S)

The present disclosure is part of a non-provisional application claiming the priority benefit of U.S. patent application Ser. No. 62/932,570, filed on 08 Nov. 2019, the content of which is incorporated by reference in its entirety.

### TECHNICAL FIELD

The present disclosure is generally related to mobile communications and, more particularly, to monitoring occasion determination for power saving signal with respect to user equipment and network apparatus in mobile communications.

### BACKGROUND

Unless otherwise indicated herein, approaches described in this section are not prior art to the claims listed below and are not admitted as prior art by inclusion in this section.

In New Radio (NR), for a user equipment (UE) in the connected mode, data exchange with the network is expected to be sporadic. The UE will spend most of its time only for monitoring physical downlink control channel (PDCCH). Even for data intensive activities such as video streaming, with improvements in data rates in NR, it is expected that the video data is buffered fairly quickly, and the UE drops into a state of data inactivity during which only PDCCH monitoring takes place. Such state will cause unnecessary power consumption and is not beneficial for UE power management.

In NR, it was agreed to introduce a power saving signal to indicate “wake-up indication”. Under the discontinuous reception (DRX) mechanism, if the UE is indicated to not to wake up, the UE will not start the DRX on duration timer, therefore, the PDCCH monitoring in the corresponding DRX cycle is not required. Thus, a wake-up indication (WUI) mechanism is proposed as an enhancement to the DRX framework for power saving at UE side. The WUI may be used to indicate to the UE to expect activities. The UE may be configured to monitor the WUI on predetermined/pre-configured occasions. If the WUI indicate the UE to wake up, the UE should wake up (e.g., exit from the power saving mode) to monitor a configured search space for downlink (DL)/uplink (UL) scheduling. If the WUI indicate the UE to not wake up, the UE can keep staying in the power saving mode.

In the WUI mechanism, the network node will configure a search space set of power saving signal for the UE to monitor the wake-up signal (WUS). The PDCCH search space refers to the area in the downlink resource grid where PDCCH may be carried. The UE will perform blind decoding throughout these search space trying to find the PDCCH data. Each search space set may comprise a plurality of monitoring occasions. The UE may be configured with multiple search space sets. Therefore, there may be a lot of monitoring occasions among multiple search space sets for the UE to monitor. However, it is not good for power management and efficiency for the UE to monitor all these monitoring occasions. It will consume significant UE power if the UE needs to monitor each monitoring occasion in the search space set. Thus, the network node should configure a reasonable range of monitoring occasions for the UE to monitor the power saving signal. However, it is not clear how to define the suitable range for monitoring and how to signal the monitoring occasions of power saving signal to the UE. Considering that multiple search spaces can be configured for WUS, more details should be considered.

Accordingly, how to design suitable range for the monitoring occasions of power saving signal becomes an important issue for the newly developed wireless communication network. Therefore, there is a need to provide proper schemes to determine and signal the monitoring occasions needed to be monitored by the UE for UE power management.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to monitoring occasion determination for power saving signal with respect to user equipment and network apparatus in mobile communications.

In one aspect, a method may involve an apparatus receiving a configuration of at least one search space set for power saving signal. The method may also involve the apparatus determining at least one monitoring occasion of the search space set according to a starting point and a monitoring 3 duration. The method may further involve the apparatus monitoring a power saving signal within the monitoring occasion. The method may further involve the apparatus determining whether to wake up from a power saving mode according to the power saving signal.

In another aspect, an apparatus may comprise a transceiver which, during operation, wirelessly communicates with a network node of a wireless network. The apparatus may also comprise a processor communicatively coupled to the transceiver. The processor, during operation, may perform operations comprising receiving, via the transceiver, a configuration of at least one search space set for power saving signal. The processor may also perform operations comprising determining at least one monitoring occasion of the search space set according to a starting point and a monitoring duration. The processor may further perform operations comprising monitoring, via the transceiver, a power saving signal within the monitoring occasion. The processor may further perform operations comprising determining whether to wake up from a power saving mode according to the power saving signal.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (loT), Narrow Band Internet of Things (NB-IoT) and Industrial Internet of Things (IIoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting example scenarios under schemes in accordance with implementations of the present disclosure.

FIG. 2 is a diagram depicting example scenarios under schemes in accordance with implementations of the present disclosure.

FIG. 3 is a diagram depicting example scenarios under schemes in accordance with implementations of the present disclosure.

FIG. 4 is a block diagram of an example communication apparatus and an example network apparatus in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to monitoring occasion determination for power saving signal with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

In NR, for a UE in the connected mode, data exchange with the network is expected to be sporadic. The UE will spend most of its time only for monitoring the PDCCH. Even for data intensive activities such as video streaming, with improvements in data rates in NR, it is expected that the video data is buffered fairly quickly, and the UE drops into a state of data inactivity during which only PDCCH monitoring takes place. Such state will cause unnecessary power consumption and is not beneficial for UE power management.

The DRX mechanism in NR that is inherited from LTE, requires the UE to intermittently monitor PDCCH, allowing the UE to transit to a sleep mode (e.g., power saving mode) in the interval. The DRX on duration defines a period of time every DRX cycle that the UE monitors for potential activity. On the occurrence of activity during the on duration (e.g., the reception of a DCI scheduling UL and/or DL activities), the DRX inactivity timer is triggered. The DRX inactivity timer restarts each time data is exchanged between the UE and the network, keeping the UE awake while data exchange takes place. On the expiry of the inactivity timer, the UE goes back to the sleep mode. The UE will monitor for activity again in next on duration.

However, the level of power savings that can be achieved with the DRX mechanism is down to the network configuration. The percentage of time in a DRX cycle that a UE needs to stay awake for directly corresponds to the power savings possible. The monitoring window of the DRX mechanism (e.g., DRX on duration) can be quite long (e.g., 10 ms) which causes the UE to burn power for downlink monitoring. The UE power consumption is unable to be properly controlled if the network configuration is not well designed or adapted. In most of time, UE monitors PDCCH during DRX on duration in DRX cycles without further data, e.g., PDSCH, reception. Such long and unnecessary PDCCH monitoring duration will consume significant UE power. Therefore, it is beneficial to only monitor PDCCH when there is data reception/transmission for the UE.

In NR, it was agreed to introduce a power saving signal (e.g., DCI format 2_6) to indicate “wake-up indication”. If the UE is indicated to not to wake up, the UE will not start the DRX on duration timer, therefore, the PDCCH monitoring in the corresponding DRX cycle is not required. Thus, a WUI mechanism is proposed as an enhancement to the DRX framework for power saving at UE side. The WUI may be used to indicate to the UE to expect activities. The UE may be configured to monitor the WUI on predetermined/pre-configured occasions. If the WUI indicate the UE to wake up, the UE should wake up (e.g., exit from the power saving mode) to monitor a configured search space for DL/UL scheduling. If the WUI indicate the UE to not wake up, the UE can keep staying in the power saving mode.

FIG. 1 illustrates example scenarios 101 and 102 under schemes in accordance with implementations of the present disclosure. Scenarios 101 and 102 involve a UE and a network node, which may be a part of a wireless communication network (e.g., an LTE network, a 5G network, an NR network, an loT network, an NB-IoT network or an lloT network). Scenario 101 illustrates the DRX mechanism in NR Release-15. The UE is configured with a DRX cycle (e.g., connected mode DRX (cDRX) cycle). In each DRX cycle, the UE is configured with a DRX on duration. In the DRX on duration, the UE must wake up to monitor PDCCH and start a DRX on duration timer (e.g., drx-onDurationTimer). When the DRX on duration timer is expired, the UE may return to the power saving mode. In an event that a DL activity (e.g., PDCCH) is detected, the UE should prolong the monitoring duration for possible DL transmissions and start a DRX inactivity timer. Until the DRX inactivity timer is expired, the UE may return to the power saving mode. When a next DRX on duration comes, the UE have to wake up again to monitor possible activities.

Scenario 102 illustrates the WUI mechanism proposed in NR Release-16. The UE may be configured to enter into a power saving mode. Before each on duration, the network node may transmit a WUS first to indicate the UE whether it should wake up from the power saving mode for possible DL/UL transmissions or link maintenance activities. The WUS may comprise one bit to represent the WUI. In an event that the WUS indicates the UE to wake up (e.g., WUI=1), the WUS may trigger the UE to wake up for an on duration or active time. In an event that the WUS indicates the UE to not wake up (e.g., WUI=0, the UE may be configured to stay in the power saving mode and not to wake up since no data exchange is expected. Instead of waking up periodically (e.g., periodic DRX on duration), the UE may monitor the WUS first to determine whether it should wake up for the on duration.

In the WUI mechanism, the network node will configure a search space set for the UE to monitor the WUS. The PDCCH search space refers to the area in the downlink resource grid where PDCCH may be carried. The UE will perform blind decoding throughout these search space trying to find the PDCCH data (e.g., DCI). Each search space set may comprise a plurality of monitoring occasions. The UE may be configured with multiple search space sets. Therefore, there may be a lot of monitoring occasions among multiple search space sets for the UE to monitor. However, it is not good for power management and efficiency for the UE to monitor all these monitoring occasions. It will consume significant UE power if the UE needs to monitor each monitoring occasion in the search space set. Thus, the network node should configure a reasonable range of monitoring occasions for the UE to monitor the power saving signal. However, it is not clear how to define the suitable range for monitoring and how to signal the monitoring occasions of power saving signal to the UE. Considering that multiple search spaces can be configured for WUS, more details should be considered.

In view of the above, the present disclosure proposes a number of schemes pertaining to monitoring occasion determination for power saving signal with respect to the UE and the network apparatus. According to the schemes of the present disclosure, the network node will signal the UE some parameters comprising an offset value and a monitoring duration. The monitoring duration may be a pre-determined number of monitoring occasions or a pre-determined monitoring window. The UE can determine at least one monitoring occasion it needs to monitor according to the offset value and the monitoring duration. Thus, the UE only need to monitor the power saving signal within the determined monitoring occasion. Then, the UE may determine whether to wake up from a power saving mode according to the power saving signal. Accordingly, which monitoring occasions need to be monitored can be clearly defined and signaled. The UE only need to monitor the monitoring occasions determined in accordance with the schemes proposed in the present disclosure. The UE does not need to monitor all or other monitoring occasions of the configured search space sets. The UE power consumption can be further reduced.

FIG. 2 illustrates example scenarios 201 and 202 under schemes in accordance with implementations of the present disclosure. Scenarios 201 and 202 involve a UE and at least one network node, which may be a part of a wireless communication network (e.g., an LTE network, a 5G network, an NR network, an loT network, an NB-IoT network or an IloT network). Scenario 201 illustrates one of monitoring occasion determination schemes in accordance with implementations of the present disclosure. The UE may be configured with DRX mode operation. The UE may receive a configuration (e.g., radio resource control (RRC) configuration) of a number of search space sets to monitor PDCCH for detection of DCI format 2_6. For example, the UE may be configured with a first search space set (e.g., search space #1) and a second search space set (e.g., search space #2). Each search space set may comprise periodic cycles (e.g., monitoring periodicity). Each cycle may comprise one or more monitoring occasions. The monitoring occasion may comprise slots/symbols for PDCCH monitoring.

The UE may be configured with parameters (e.g., RRC parameters) for determining the monitoring occasions for the power saving signal/wake-up signal. The parameters may be signaled, for example and without limitation, in the search space information element (IE). The parameters may comprise an offset value (e.g., PS_offset). The UE may determine a starting point for monitoring according to the offset value. For example, the UE may start monitoring the power saving signal (e.g., PDCCH with cyclic redundancy check (CRC) scrambled by power saving-radio network temporary identifier (PS-RNTI)) at the configured PS_offset before the start of DRX on duration (e.g., start of the drx-onDurationTimer) for an upcoming DRX cycle indicated by higher layer signaling (e.g., RRC signaling). The starting point may be determined at tₛₜₐᵣₜ as illustrated in FIG. 2. The PS_offset may be a higher layer parameter. In addition to PS_offset, the UE also needs to know the monitoring duration for determining the range of monitoring.

The UE may be configured to determine at least one monitoring occasion of the search space sets for power saving signal according to the starting point and the monitoring duration. For example, as shown in scenario 201, the UE may be configured to determine a first valid monitoring occasion of a search space set for power saving signal. The first valid monitoring occasion may be the monitoring occasion which is closest to the starting point (e.g., tstart) but not prior to the starting point. Furthermore, the UE needs to determine how many monitoring occasions should be monitored (e.g., the range of monitoring). The UE may be configured to determine a number of monitoring occasions to monitor according to the monitoring duration in the search space configuration received in higher layer signaling (e.g., RRC signaling). The number of monitoring occasions may be a first number of slots indicated by the monitoring duration starting from the starting point and prior to the start of the DRX on duration timer. For example, the UE may determine a number of monitoring occasions according to the parameters (e.g., duration and monitoringSymbolsWithinSlot) in the search space IE. For each search space set, the PDCCH monitoring occasions are the ones in the first Tₛ slots indicated by the parameter “duration”, or Tₛ=1 slot if “duration” is not provided, starting from the first slot of the first Tₛ slots and ending prior to the start of the DRX on duration timer. The number of monitoring occasions may be different between different search space sets.

Accordingly, as shown in scenario 201, for search space #1, the valid monitoring occasion(s) for power saving signal is the monitoring occasion(s) in the first slot which is closest to the starting point but not prior to the starting point wherein the duration parameter of search space #1 is 1. For search space #2, the valid monitoring occasions for power saving signal are the monitoring occasions in the first two slots which is closest to the starting point but not prior to the starting point wherein the duration parameter of search space #2 is 2. Thus, in one DRX cycle (e.g., DRX long cycle), the UE only need to monitor the power saving signal within the valid monitoring occasions of search space #1 and search space #2. Then, the UE may determine whether to wake up from the power saving mode according to the power saving signal.

Scenario 202 illustrates another scheme for monitoring occasion determination in accordance with implementations of the present disclosure. In this scheme, the monitoring duration may be a monitoring window indicated by a higher layer parameter (e.g., RRC parameter). For example, a new higher layer parameter (e.g., PS_range) may be introduced to indicate a window where the UE needs to monitor power saving signal. Any monitoring occasion located in the window (e.g., from PS_offset to “PS_offset-PS_range”) are valid. Accordingly, one or more than one period of the search space set may be included in the monitoring window. The UE may be configured to monitor the power saving signal within the monitoring occasions located in the monitoring window.

From UE perspective, the timing gap between the last monitoring occasion and the first slot of DRX on duration should be large enough to leave sufficient time for the UE to transit from inactive time (e.g., lower clock/voltage in the power saving mode) to active time (e.g., higher clock/voltage in the normal mode). The timing gap can be UE capability and SCS dependent. For 13 example, the timing gap needed by a UE may depend on its hardware and/or software capability for transiting from the power saving mode to the normal mode. Therefore, the UE may be configured to transmit a capability report to indicate the needed timing gap to the network node. The timing gap may be defined between the last slot where UE monitors power saving signal and the first slot of DRX on duration. Alternatively, the timing gap may be defined between the end of last slot where UE monitors power saving signal (e.g., slot index for last slot where UE monitors power saving signal +1) and the first slot of DRX on duration. For example, the reported timing gap may comprise 0 slot (e.g., no timing gap) for 15 kHz SCS and 1 slot for 30/60/120 kHz SCS. The UE doesn't have to monitor the monitoring occasion that doesn't meet its UE capability.

In some implementations, in an event that the UE reports for an active downlink bandwidth part (BWP) a required number of slots (e.g., X slots) prior to a beginning of a slot where a DRX on duration timer is started, the UE is not required to monitor the PDCCH for detection of DCI format 2_6 during the X slots, where X corresponds to the requirement of the SCS of the active downlink BWP. The UE may determine the required number of slots according to at least one of the SCS and the UE capability. The UE may be configured to cancel the monitoring of the power saving signal within the required number of slots prior to the beginning of the slot where the DRX on duration timer is started.

FIG. 3 illustrates example scenarios 301 and 302 under schemes in accordance with implementations of the present disclosure. Scenarios 301 and 302 involve a UE and at least one network node, which may be a part of a wireless communication network (e.g., an LTE network, a 5G network, an NR 14 network, an loT network, an NB-IoT network or an IloT network). Scenario 301 illustrates the UE capability report based on the scheme illustrated in scenario 201. Under the scheme of scenario 201, the UE capability report is based on the range between the end of last slot where UE monitors power saving signal and the beginning of the slot where the DRX on duration timer is started. Thus, the network configuration should consider the monitoring occasions of all configured search space sets for power saving signal. After receiving the capability report from the UE, the network node should configure the valid monitoring occasions for the power saving signal by considering the required number of slots reported by the UE.

Scenario 302 illustrates the UE capability report based on the scheme illustrated in scenario 202. Under the scheme of scenario 202, the UE capability report is based on the end of monitoring range and the beginning of the slot where the DRX on duration timer is started. Thus, the network node only needs to ensure that the timing gap between the end of monitoring range (e.g., time instance for “PS_offset-PS_range”) and the starting of DRX on duration can meet UE capability. After receiving the capability report from the UE, the network node should configure the monitoring window for the power saving signal by considering the required number of slots reported by the UE. Illustrative Implementations

FIG. 4 illustrates an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to monitoring occasion determination for power saving signal with respect to user equipment and network apparatus in wireless communications, including scenarios/schemes described above as well as process 500 described below.

Communication apparatus 410 may be a part of an electronic apparatus, which may be a UE such as a portable or mobile apparatus, a wearable apparatus, a wireless communication apparatus or a computing apparatus. For instance, communication apparatus 410 may be implemented in a smartphone, a smartwatch, a personal digital assistant, a digital camera, or a computing equipment such as a tablet computer, a laptop computer or a notebook computer. Communication apparatus 410 may also be a part of a machine type apparatus, which may be an loT, NB-IoT, or IIoT apparatus such as an immobile or a stationary apparatus, a home apparatus, a wire communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4 such as a processor 412, for example. Communication apparatus 410 may further include one or more other components not pertinent to the proposed scheme of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of an electronic apparatus, which may be a network node such as a base station, a small cell, a router or a gateway. For instance, network apparatus 420 may be implemented in an eNodeB in an LTE, LTE-Advanced or LTE-Advanced Pro network or in a gNB in a 5G, NR, loT, NB-IoT or IIoT network. Alternatively, network apparatus 420 may be implemented in the form of one or more IC chips such as, for example and without limitation, one or more single-core processors, one or more multi-core processors, or one or more RISC or CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including power consumption reduction in a device (e.g., as represented by communication apparatus 410) and a network (e.g., as represented by network apparatus 420) in accordance with various implementations of the present disclosure.

In some implementations, communication apparatus 410 may also include a transceiver 416 coupled to processor 412 and capable of wirelessly transmitting and receiving data. In some implementations, communication apparatus 410 may further include a memory 414 coupled to processor 412 and capable of being accessed by processor 412 and storing data therein. In some implementations, network apparatus 420 may also include a transceiver 426 coupled to processor 422 and capable of wirelessly transmitting and receiving data. In some implementations, network apparatus 420 may further include a memory 424 coupled to processor 422 and capable of being accessed by processor 422 and storing data therein. Accordingly, communication apparatus 410 and network apparatus 420 may wirelessly communicate with each other via transceiver 416 and transceiver 426, respectively. To aid better understanding, the following description of the operations, functionalities and capabilities of each of communication apparatus 410 and network apparatus 420 is provided in the context of a mobile communication environment in which communication apparatus 410 is implemented in or as a communication apparatus or a UE and network apparatus 420 is implemented in or as a network node of a communication network.

In some implementations, processor 412 may be configured with DRX mode operation. Processor 412 may receive, via transceiver 416, a configuration (e.g., RRC configuration) of a number of search space sets to monitor PDCCH for detection of DCI format 2_6. For example, processor 412 may be configured with a first search space set and a second search space set.

In some implementations, processor 412 may be configured with parameters (e.g., RRC parameters) for determining the monitoring occasions for the power saving signal. The parameters may be signaled in the search space IE. The parameters may comprise an offset value (e.g., PS_offset). Processor 412 may determine a starting point for monitoring according to the offset value. For example, processor 412 may start monitoring the PDCCH with CRC scrambled by PS-RNTI at the configured PS_offset before the start of DRX on duration. In addition to PS_offset, processor 412 also needs to know the monitoring duration for determining the range of monitoring.

In some implementations, processor 412 may be configured to determine at least one monitoring occasion of the search space sets for power saving signal according to the starting point and the monitoring duration. For example, processor 412 may be configured to determine a first valid monitoring occasion of a search space set for power saving signal. The first valid monitoring occasion may be the monitoring occasion which is closest to the starting point but not prior to the starting point. Furthermore, processor 412 needs to determine how many monitoring occasions should be monitored (e.g., the range of monitoring). Processor 412 may be configured to determine a number of monitoring occasions to monitor according to the monitoring duration in the search space configuration received in higher layer signaling (e.g., RRC signaling). The number of monitoring occasions may be a first number of slots indicated by the monitoring duration starting from the starting point and prior to the start of the DRX on duration timer. For example, processor 412 may determine a number of monitoring occasions according to the parameters (e.g., duration and monitoringSymbolsWithinSlot) in the search space IE.

In some implementations, for the first search space set, processor 412 may determine that the valid monitoring occasion(s) for power saving signal is the monitoring occasion(s) in the first slot which is closest to the starting point but not prior to the starting point wherein the duration parameter of the first search space set is 1. For the second search space set, processor 412 may determine that the valid monitoring occasions for power saving signal are the monitoring occasions in the first two slots which is closest to the starting point but not prior to the starting point wherein the duration parameter of the second search space set is 2. Thus, in one DRX cycle (e.g., DRX long cycle), processor 412 only need to monitor the power saving signal within the valid monitoring occasions of the first search space set and the second search space set. Then, processor 412 may determine whether to wake up from the power saving mode according to the power saving signal.

In some implementations, network apparatus 420 may configure the monitoring duration by using a monitoring window indicated by a parameter. For example, network apparatus 420 may use a new higher layer parameter (e.g., PS_range) to indicate a window where processor 412 needs to monitor power saving signal. Any monitoring occasion located in the window (e.g., from PS_offset to “PS_offset-PS_range”) are valid. Accordingly, network apparatus 420 may configure more than one period of the search space set in the monitoring window. Processor 412 may be configured to monitor the power saving signal within the monitoring occasions located in the monitoring window.

In some implementations, the timing gap between the last monitoring occasion and the first slot of DRX on duration should be large enough to leave sufficient time for communication apparatus 410 to transit from inactive time to active time. The timing gap can be UE capability and SCS dependent. For example, the timing gap needed by communication apparatus 410 may depend on its hardware and/or software capability for transiting from the power saving mode to the normal mode. Therefore, processor 412 may be configured to transmit, via transceiver 416, a capability report to indicate the needed timing gap to network apparatus. Processor 412 doesn't have to monitor the monitoring occasion that doesn't meet its capability.

In some implementations, in an event that processor 412 reports for an active downlink BWP a required number of slots (e.g., X slots) prior to a beginning of a slot where a DRX on duration timer is started, processor 412 is not required to monitor the PDCCH for detection of DCI format 2_6 during the X slots, where X corresponds to the requirement of the SCS of the active downlink BWP. Processor 412 may determine the required number of slots according to at least one of the SCS and its capability. Processor 412 may be configured to cancel the monitoring of the power saving signal within the required number of slots prior to the beginning of the slot where the DRX on duration timer is started.

21

In some implementations, network apparatus 420 should consider the monitoring occasions of all configured search space sets for power saving signal. After receiving the capability report from communication apparatus 410, network apparatus 420 should configure the valid monitoring occasions for the power saving signal by considering the required number of slots reported by communication apparatus 410.

In some implementations, network apparatus 420 only needs to ensure that the timing gap between the end of monitoring range (e.g., time instance for “PS_offset-PS_range”) and the starting of DRX on duration can meet the capability of communication apparatus 410. After receiving the capability report from communication apparatus 410, network apparatus 420 should configure the monitoring window for the power saving signal by considering the required number of slots reported by communication apparatus 410.

### Illustrative Processes

FIG. 5 illustrates an example process 500 in accordance with an implementation of the present disclosure. Process 500 may be an example implementation of above scenarios/schemes, whether partially or completely, with respect to monitoring occasion determination for power saving signal with the present disclosure. Process 500 may represent an aspect of implementation of features of communication apparatus 410. Process 500 may include one or more operations, actions, or functions as illustrated by one or more of blocks 510, 520, 530 and 540. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively, in a different order. Process 500 may be implemented by communication apparatus 410 or any suitable UE or machine type devices. Solely for illustrative purposes and without limitation, process 500 is described below in the context of communication apparatus 410. Process 500 may begin at block 510.

At 510, process 500 may involve processor 412 of apparatus 410 receiving a configuration of at least one search space set of power saving signal. Process 500 may proceed from 510 to 520.

At 520, process 500 may involve processor 412 determining at least one monitoring occasion of the search space set according to a starting point and a monitoring duration. Process 500 may proceed from 520 to 530.

At 530, process 500 may involve processor 412 monitoring a power saving signal within the monitoring occasion. Process 500 may proceed from 530 to 540.

At 540, process 500 may involve processor 412 determining whether to wake up from a power saving mode according to the power saving signal.

In some implementations, process 500 may involve processor 412 determining a first monitoring occasion which is closest to the starting point but not prior to the starting point.

In some implementations, process 500 may involve processor 412 determining a number of monitoring occasions to monitor according to the monitoring duration.

In some implementations, the number of monitoring occasions comprises a first number of slots indicated by the monitoring duration starting from the starting point and prior to a start of a DRX on duration timer.

In some implementations, the number of monitoring occasions is different between different search space sets.

In some implementations, the monitoring duration may comprise a monitoring window indicated by a higher layer parameter.

In some implementations, the at least one monitoring occasion comprised in the monitoring window may comprise one or more than one period of the search space set.

In some implementations, process 500 may involve processor 412 transmitting a required number of slots prior to a beginning of a slot where a DRX on duration timer is started to a network node.

In some implementations, process 500 may involve processor 412 cancelling the monitoring of the power saving signal within the required number of slots.

In some implementations, process 500 may involve processor 412 determining the required number of slots according to at least one of an SCS and a capability.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a configuration of at least one search space set of power saving signal;
determining, by the processor, at least one monitoring occasion of the search space set according to a starting point and a monitoring duration;
monitoring, by the processor, a power saving signal within the monitoring occasion; and
determining, by the processor, whether to wake up from a power saving mode according to the power saving signal.

2. The method of claim 1, wherein the determining of the at least one monitoring occasion comprises determining a first monitoring occasion which is closest to the starting point but not prior to the starting point.

3. The method of claim 1, wherein the starting point comprises an offset value before a start of a discontinuous reception (DRX) on duration timer.

4. The method of claim 1, wherein the determining of the at least one monitoring occasion comprises determining a number of monitoring occasions to monitor according to the monitoring duration.

5. The method of claim 4, wherein the number of monitoring occasions comprises a first number of slots indicated by the monitoring duration starting from the starting point and prior to a start of a discontinuous reception (DRX) on duration timer.

6. The method of claim 1, wherein the monitoring duration comprises a monitoring window indicated by a higher layer parameter.

7. The method of claim 6, wherein the at least one monitoring occasion comprised in the monitoring window comprises one or more than one period of the search space set.

8. The method of claim 1, further comprising:
transmitting, by the processor, a required number of slots prior to a beginning of a slot where a discontinuous reception (DRX) on duration timer is started to a network node.

9. The method of claim 8, further comprising:
cancelling, by the processor, the monitoring of the power saving signal within the required number of slots.

10. The method of claim 8, further comprising:
determining, by the processor, the required number of slots according to at least one of a sub-carrier spacing (SCS) and a capability.

11. An apparatus, comprising:
a transceiver which, during operation, wirelessly communicates with a network node of a wireless network; and
a processor communicatively coupled to the transceiver such that, during operation, the processor performs operations comprising:
receiving, via the transceiver, a configuration of at least one search space set of power saving signal;
determining at least one monitoring occasion of the search space set according to a starting point and a monitoring duration;
monitoring, via the transceiver, a power saving signal within the monitoring occasion; and
determining whether to wake up from a power saving mode according to the power saving signal.

12. The apparatus of claim 11, wherein, in determining the at least one monitoring occasion, the processor determines a first monitoring occasion which is closest to the starting point but not prior to the starting point.

13. The apparatus of claim 11, wherein the starting point comprises an offset value before a start of a discontinuous reception (DRX) on duration timer.

14. The apparatus of claim 11, wherein, in determining the at least one monitoring occasion, the processor determines a number of monitoring occasions to monitor according to the monitoring duration.

15. The apparatus of claim 14, wherein the number of monitoring occasions comprises a first number of slots indicated by the monitoring duration starting from the starting point and prior to a start of a discontinuous reception (DRX) on duration timer.

16. The apparatus of claim 11, wherein the monitoring duration comprises a monitoring window indicated by a higher layer parameter.

17. The apparatus of claim 16, wherein the at least one monitoring occasion comprised in the monitoring window comprises one or more than one period of the search space set.

18. The apparatus of claim 11, wherein, during operation, the processor further performs operations comprising:
transmitting, via the transceiver, a required number of slots prior to a beginning of a slot where a discontinuous reception (DRX) on duration timer is started to a network node.

19. The apparatus of claim 18, wherein, during operation, the processor further performs operations comprising:
cancelling the monitoring of the power saving signal within the required number of slots.

20. The apparatus of claim 18, wherein, during operation, the processor further performs operations comprising:
determining the required number of slots according to at least one of a sub-carrier spacing (SCS) and a capability.
